(19) United States
(12) Patent Application Publication
(10) Pub. No.: US 2009/0276757 A1
(43) Pub. Date: Nov. 5, 2009

(54) Systems and methods for inference and management of software code architectures

(75) Inventors: Mikael Lindvall, Greenbelt, MD (US); Dirk Muthig, Kaiserslautern (DE); Patricia Costa, Croton-on-Hudson, NY (US); Jens Knodel, Kaiserslautern (DE)

Correspondence Address: STERNE, KESSLER, GOLDSTEIN & FOX P.L.L.C., 1100 NEW YORK AVENUE, N.W., WASHINGTON, DC, 20005, US

(73) Assignees: Fraunhofer USA, Inc., Plymouth, MI (US); Fraunhofer-Gesellschaft zur Forderung der angewandten Forschung e.V, Munchen (DE)

(21) Appl. No.: 12/112,269

(22) Filed: Apr. 30, 2008

(51) Int. Cl. G06F 9/44

(52) U.S. Cl. 717/121

(57) ABSTRACT

Systems, computer program products, and methods for extracting, evaluating, and updating the architecture of a software system are provided. In an embodiment, the method operates by defining the planned architecture for the system and extracting the implemented software code architecture from the source code of the system. The method compares the actual architecture to the planned architecture defined to identify architectural deviations, and suggested changes to the architecture are identified based upon the architectural deviations. The modeled code architecture and defined planned architecture information enables verification and determination of whether a software system's source code conforms to the intended structure of the system. The code architecture and planned architecture comparison also enables analysis and display of the effects that changes to source code may have on the structure of a software system.

### BACKGROUND OF THE INVENTION

1. Field of the Invention

The present invention relates to software architecture, and more particularly, to inferring, modeling, and displaying software code architecture from the source code of a software system.

2. Background

A software architecture describes the structure of, and relationships among, components in a software system. The importance of structure in the design of software has long been recognized. Among the benefits of software architecture identification is pointing out how software development and maintenance costs can be reduced. These benefits can be more readily realized if the software system has a clearly understood and articulated partitioning of functionality among subsystems.

Software architecture is commonly organized into views, which describe the architecture in question from the perspective of a given set of stakeholders and their concerns. One of the most important views of a software architecture is the code view, also referred to as the code architecture. The code architecture of a software system describes its source-code components, such as files, packages, and classes. The code architecture also describes interactions between source code components such as function calls, method calls, variable accesses, exception and error handling, inheritance, file inclusion, message passing, and other components.

Knowledge about the code architecture of a software system is useful to software developers and maintainers in order to enable them to understand software systems and to ensure that software systems are built according to design.

The development ‘lifecycle’ of software systems typically includes analysis, design, implementation, and testing phases. It is crucial to document the software architecture, as it evolves and changes during the development lifecycle of a software system. The code architecture provides information from different points of view and different levels of detail and serves as the foundation for subsequent decisions concerning the final, implemented, software product. A software system's code architecture is used as a primary source of information for various stakeholders of the software system (i.e., people who have an interest in the software system, such as software architects, software developers, users, and customers). Software developers have a particularly acute need for up-to-date information regarding a software system's code architecture as they create various artifacts based upon architecture knowledge. These artifacts in turn define attributes of the final, implemented, ‘as built’ software system.

Unfortunately, code architecture knowledge is often not recorded, and even when it is recorded and documented, code architecture documentation is often out of date and/or inconsistent with the current code architecture in the actual ‘as built’ software system. Many software project failures and cost overruns can be attributed to the lack of precise information about the code architecture. Lack of knowledge of code architecture can also cause the architecture of a software system to degenerate during implementation. Degeneration of an architecture negatively impacts software system quality, maintainability, reliability security, and extensibility. These problems increase as the software system grows and creates the need to modify the software system code to bring it into closer alignment with the planned architecture. Subsequent modifications or restructurings are performed as additional elements are changed by software developers. These modifications require additional effort and resources to keep the software architecture updated.

Source code modifications late in the software development lifecycle cause unnecessary effort in the testing and implementation phases of the software development lifecycle. Software is often developed and implemented by teams, and these teams are often distributed and not physically co-located. The distributed nature of many software development teams can result in team member's work being managed by a central configuration management or version control system, running on a server, and accessible by all team members.

The distributed nature of software development also has the unintended effect of contributing to conflicts between code and modules written by different implementers who are working on related elements or the same element. For a software implementer who wants to commit or save work, this requires additional effort to merge changes with prior changes in order to avoid inconsistencies.

The original developers of source code for implemented software systems are often unavailable when subsequent maintenance or enhancement-related changes need to be made to the software systems. This is particularly true for larger, more complex software systems which are typically developed by larger development teams. It is not uncommon for software development teams to experience developer attrition during the lifecycle and lifespan of a software system. This developer attrition carries the cost of lost knowledge regarding software system architecture when developers with architecture knowledge are unavailable. This problem is particularly acute when the architecture documentation is outdated or otherwise lacking.

Even in cases where all of the developers of a software system are available, software systems are often implemented without adequate or up-to-date documentation regarding their final ‘as built’ architecture. Regardless of developer or documentation availability, the source code of a software system is usually readily available.

Accordingly, what is needed are computer program products, methods, and systems that evaluate and manage a software system's architecture in a cost-effective manner.

Accordingly, what is also needed are computer program products, methods, and systems that enable software implementers to determine if source code being implemented is consistent with the architecture guidelines and design for software systems.

### SUMMARY OF THE INVENTION

The present invention provides methods, computer program products, and systems for evaluating and managing the architecture of a software system. The methods, computer program products, and systems build an abstract model of the code and planned architectures of a software system, wherein the model comprises conceptual components identified by users. The abstract model of the code architecture documents the dependencies between the conceptual components identified and selected by the users. The abstract models of the code and planned architectures are displayed to enable comparison of the code and planned architectures.

The present invention includes a system for evaluating the code architecture of a software system. The system includes an architecture definition that defines the planned architecture of the software system. The defined architecture includes design metrics and architecture evaluation guidelines. The system also includes a fact extraction module that extracts the code architecture from the source code of a software system. The system further includes a mapping module that maps items in the code architecture to items in the planned architecture and a comparison module that compares the code architecture to the planned architecture in order to identify architectural deviations. The system also includes a display module that graphically displays architectural deviations identified by the comparison module. The display module displays a software system's current code architecture in order to provide feedback to software developers about the architectural impact of code changes that are implemented, raise architectural awareness, and warn developers of potential conflicts between their code changes and another developer's changes in a timely manner in order to avoid architectural degeneration and the need to subsequently merge such changes. The display module reveals the architectural context of contemplated code changes to software developers by displaying the architectural impact of the code changes.

The present invention provides methods, computer program products, and systems that build and compare abstract models of code and planned architectures, wherein the model of the planned architecture consists of conceptual components identified by the user and the dependencies between components, and wherein the models have the same level of abstraction in order to facilitate comparison.

The present invention provides methods, computer program products, and systems that model a software system's code and planned architectures wherein the code architecture is derived from a concrete file system model, and wherein the code architecture model describes dependencies, such as method/function invocations, variable access between files and directories that contain source code.

Further embodiments, features, and advantages of the invention, as well as the structure and operation of the various embodiments of the invention are described in detail below with reference to accompanying drawings.

### BRIEF DESCRIPTION OF THE FIGURES

The present invention is described with reference to the accompanying drawings. In the drawings, like reference numbers indicate identical or functionally similar elements. The drawing in which an element first appears is indicated by the left-most digit in the corresponding reference number.

FIG. 1 illustrates a sample architecture in which the client component has a relation to a server component due to a method call, according to an embodiment of the invention.

FIG. 2 depicts a sample architecture with a client component comprising two sub components.

FIG. 3 provides a legend for Unified Modeling Language (UML) class diagrams of FIGS. 4-7.

FIG. 4 provides a UML diagram depicting the Architecture Component Model, according to an embodiment of the invention.

FIG. 5 provides a UML diagram depicting the File System Model, according to an embodiment of the invention.

FIG. 6 provides a UML diagram depicting the Architecture File System Connector model, according to an embodiment of the invention.

FIG. 7 provides a UML diagram for the architecture inference core model, according to an embodiment of the invention.

FIG. 8 illustrates pre-processing and a file structure for a software project to be extracted, according to an embodiment of the invention.

FIG. 9 provides a component diagram of the folder-based component definition strategy, according to an embodiment of the invention.

FIG. 10 provides a component diagram of the file-based component definition strategy, according to an embodiment of the invention.

FIG. 11 illustrates the software architecture inference and modeling process, in accordance with an embodiment of the present invention.

FIG. 12 depicts a display of a model for a planned software application architecture, in accordance with an embodiment of the present invention.

FIG. 13 depicts a display of an actual code architecture, in accordance with an embodiment of the present invention.

FIG. 14 depicts a display of deviations (architectural violations) between a planned and an actual code architecture, in accordance with an embodiment of the present invention.

FIG. 15, depicts a detailed display of architectural violations between a planned and an actual code architecture, in accordance with an embodiment of the present invention.

FIG. 16 is a diagram of a computer system on which the methods and systems herein described can be implemented, according to an embodiment of the invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

### 1.0 Structural Embodiments

Embodiments of the present invention are described primarily in the context of a software system. It should, however, be understood that the invention is not limited to the exemplary software system described herein. The present invention may be used for a variety of software systems written in various programming languages, as would be recognized by persons of skill in the art.

Unless specifically stated differently, a user, developer, or team member is interchangeably used herein to identify a human user, a software agent, or a group of users and/or software agents. Besides a human user who needs to infer and model code architecture, a software application or agent sometimes needs to update and access code architectures. Accordingly, unless specifically stated, the term “user” and “developer” as used herein does not necessarily pertain to a human being.

“Data” as used herein may be any object, including, but not limited to, information in any form (source code files, source code text, binary files, executable files) and applications.

According to an embodiment of the present invention, an abstract model of a software system is derived from a concrete file system model, wherein the file system model is constructed by the methods, computer program products, and systems. The file system model describes the dependencies between the software system's components, such as method invocations, function calls, variable access, and other dependencies between the files and directories that contain the software system's source code.

According to an embodiment of the invention, dependencies are computed by analyzing the contents of each source code file to determine which entities defined in other files are accessed within that file. In accordance with an embodiment of the present invention, a mapping between the abstract model and the file system model is maintained to provide explicit linkages between elements in the abstract model and their corresponding elements in the software system's source code. According to one embodiment of the invention, the explicit linkage is used to navigate between abstract views of the code architecture from the highest-level elements to the source code details.

In accordance with one aspect of the invention, the dependencies between conceptual components are computed by analyzing the contents of each software source code file to determine which entities defined in other source code files are referred to by each source code file.

### 1.1 Basic Concepts

Code architectural evaluation includes the steps of defining and documenting the code architecture, communicating and displaying the architecture so that it can be visualized, and subsequently evaluating each change to the architecture.

Architectural evaluations may be conducted with different goals in mind and from different perspectives. For example, a system might be evaluated to determine whether or not the software system implements the specified functional requirements or to determine if it fulfills the non-functional requirements (i.e., the software system qualities or quality attributes). Other examples of perspectives are evaluations for software system security, reliability, performance, and maintainability.

A code architecture consists of components and relations between the components. A component is a collection of software source code units that collaboratively discharge certain functionality. For example, components can be clients or servers.

A relation is a dependency between two components that occurs when one component refers to the other component. A dependency can be a method or function call. A call is an invocation by a component that calls another component's method or function. A dependency can also be an import (or include), wherein an import is when a component imports definitions inside another component. A dependency can also be an inheritance, wherein an inheritance is when a component inherits variable declarations, definitions, data types, name resolutions, or other attributes from another component. Dependencies can also arise when a component implements the interface of another component or when a component accesses a variable in another component.

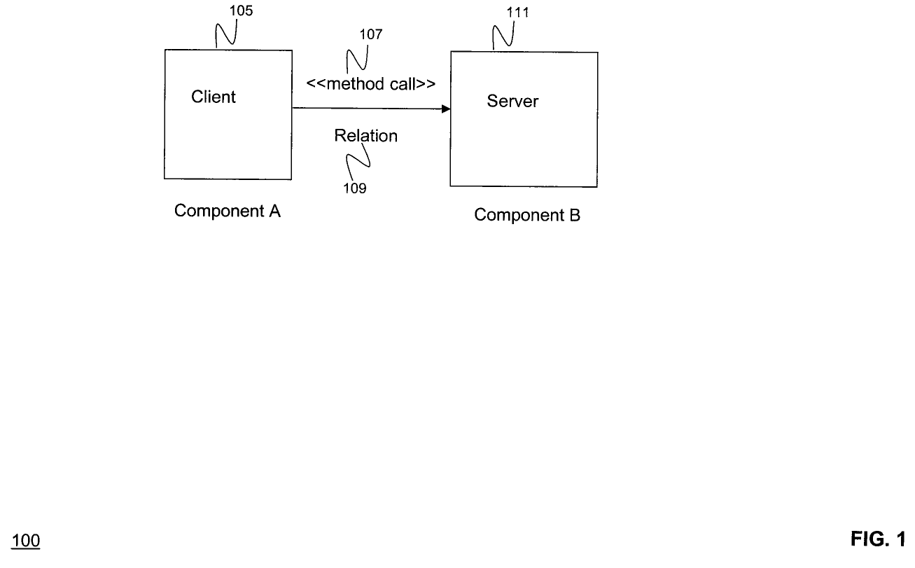

FIG. 1 provides an exemplary software architecture 100, according to embodiments of the present invention.

Exemplary software architecture 100 includes two components, client 105 and server 111. Software architecture 100 is hierarchical in nature i.e., client component 105 may in turn consist of other components that collaborate through relations in order to provide a certain functionality.

In the example in FIG. 1, server 111 is a component and client 105 is a separate component, wherein each may consist of respective other subcomponents. Method call 107 occurs and relation 109 arises when client component 105 calls method 107 in a server component such as server 111.

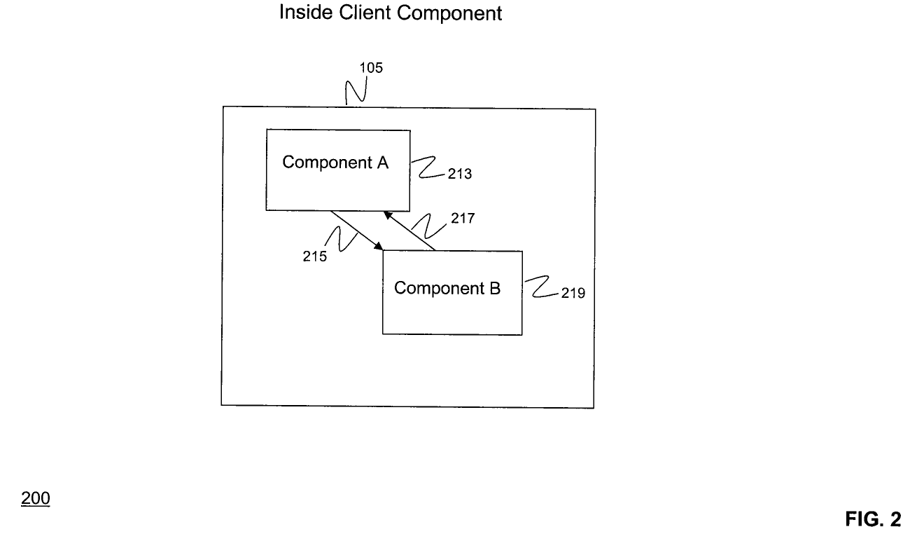

In FIG. 2, the hierarchical structure of code architecture 200 is depicted by illustrating a detailed, internal view of client 105. Client 105 is a client component that has its own architecture consisting of components 213 (component A) and 219 (component B) and relationships 215 and 217. Component 213 is related to component 219 via relationship 215. Similarly, component 219 is related to component 213 by relationship 217.

### 1.2 Aspects

There are three different aspects involved in the architecture extraction and inference process: the programming language aspect; the file system aspect; and the architecture aspect. Each of these aspects is described in the sections below.

### 1.3 Programming Language Aspect

A programming language compilation unit consists of a sequence of commands rendered in the syntax of the programming language that the software system being modeled was written in. Some of these commands depend on non-contiguous syntactic blocks, wherein the blocks are often stored in distinct compilation units. According to an embodiment of the present invention, a method invocation passes control to a region of code which may be located in a syntactic block that is not contiguous to the calling statement.

### 1.4 The File System Aspect

The file system aspect represents the way in which compilation units are stored on a storage device, in the form of files (the atomic units of the file system aspect) and directories (hierarchically organized collections of files and subdirectories). A file may be associated with a compilation unit. Two or more files have a relationship between them if their corresponding compilation units have a relationship between them. Two or more directories have a relationship between them if any file contained inside one of the directories is related to another file contained in one of the other directories via a relationship.

### 1.5 Architecture Aspect

The architecture aspect contains conceptual components and the relations between them. A conceptual component corresponds to a file/directory or collection thereof: these conceptual components must be specified by the user of the embodiment by selecting one of two strategies. A conceptual component has a relation to another conceptual component only if at least one file in one component has a relation with at least one file in another component.

In accordance with an embodiment of the invention, the file system and architecture aspects are constructed given the programming language aspect and the organization of the compilation units of the software system into files and folders. For example, the invention takes in the source files and constructs an easily-navigable representation of the source code.

According to an embodiment, the source code of the software system whose architecture is being inferred is represented as a parse tree. For example, the content of each node of the parse tree is analyzed in order to identify the entity names accessed by each node and the compilation units in which the names are declared in addition to identifying the declarations in which the nodes reside. In accordance with an embodiment of the present invention, functions/methods containing the programming language constructs corresponding to nodes are identified. The relationships in the file system aspect are constructed based upon: entity names accessed by each node, compilation units in which the entities are declared, and the declarations in which the nodes reside. Entities may include one or more of functions, data structures, data types, procedures, methods, classes, and applets.

According to an embodiment of the invention, once the conceptual component definitions are provided, relationships in the architecture aspect are built and linkages are established to the appropriate file system relations.

Features of the present invention are described and depicted with Unified Modeling Language (UML) class diagrams of the component, file system, and file system connector models to explain the data model for the core model.

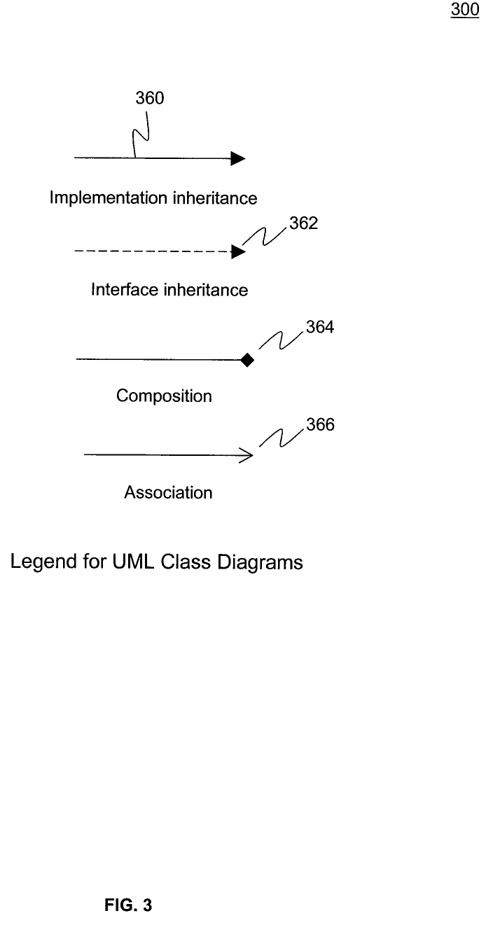

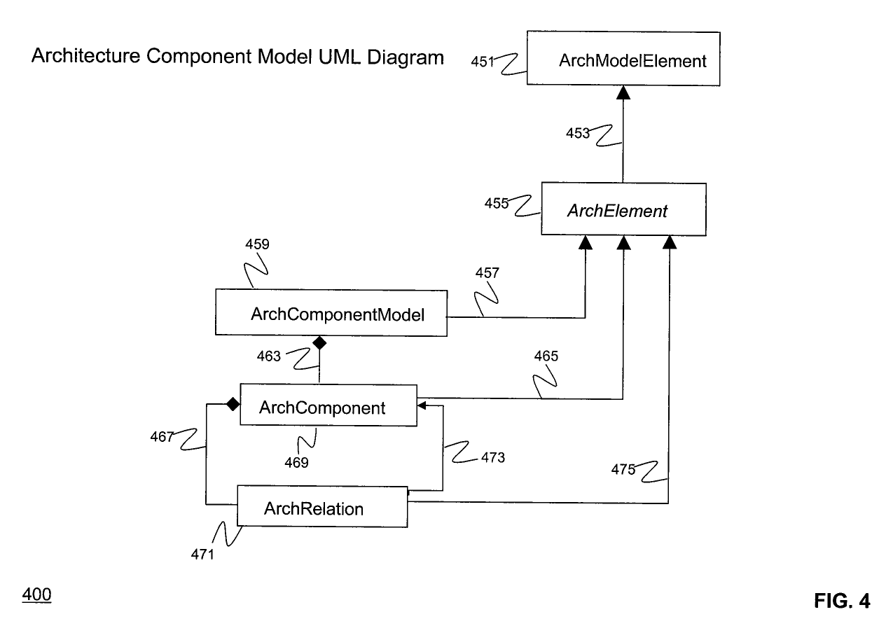

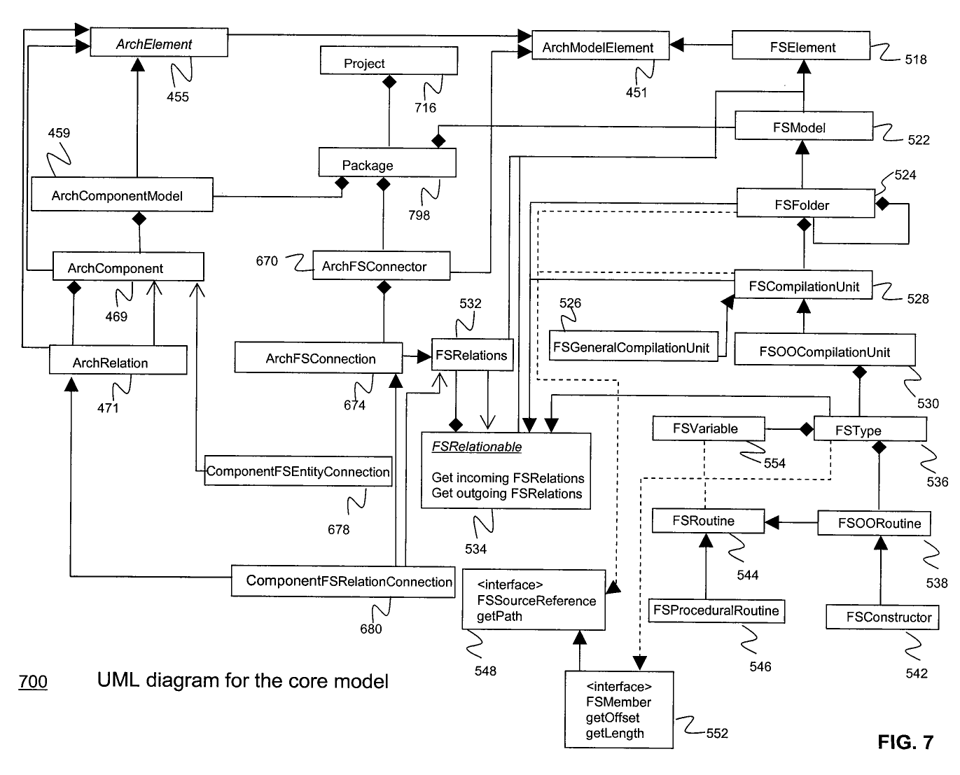

FIG. 3 contains a key illustrating the four different connector types used in the UML class diagrams used to depict the core model in FIG. 7 and the three concept spaces/models depicted in FIGS. 4-6. The four UML connector types of FIG. 3 are used in the UML diagrams of FIGS. 4-6 which in turn depict the component, file system, and file system connector models, respectively.

Connector 360 is used to depict an implementation inheritance in FIGS. 4-7 pursuant to the UML 2.0 standard. Connector 362 depicts an interface inheritance in FIGS. 4-6 and 9 pursuant to the UML 2.0 standard. Inheritance, refers to the ability of one class (i.e., a child class) to inherit the identical functionality of another class (i.e., a super class), and then add new functionality of its own. Similarly, connector 364 represents a composition in FIGS. 4-7 pursuant to the UML 2.0 standard. Aggregation is a type of association used to model a “whole to its parts” relationship. In basic aggregation relationships, the lifecycle of a part class is independent from the whole class's lifecycle. When a part class's lifecycle is not independent from that of the whole class this is a composition aggregation. Lastly, connector 366 is used to depict associations in FIGS. 4-7 pursuant to the UML 2.0 standard. When a software system is modeled, certain objects are related to each other, and these relationships themselves need to be modeled for clarity. An association is a linkage between two classes. Associations may be assumed to be bi-directional; meaning that both classes are aware of each other and their relationship to each other, unless the association is qualified the association as some other type besides bi-directional. Uni-directional associations include a role name and a multiplicity value, but unlike the bi-directional associations, uni-directional associations only contain the role name and multiplicity value for a known class.

### 1.6 Modeling Code Architecture

According to an embodiment of the invention, the code architecture views of software systems are extracted from the source code by constructing a ‘core model,’ while maintaining the explicit relationships between the core model and the original source code. More particularly, the core model contains the main data structures for building the model of the source code. Extraction of the code architecture may be conceptualized as ‘fact extraction’ wherein the facts needed to display, evaluate, and update the code architecture of a software system are extracted from the source code of a software system.

The core model can be split into three different ‘concept spaces’ that contain different types of information. According to an embodiment, the three different concept spaces comprise the component model, the file system model, and the file system connector model. These three models are described in the following sections. The core model is described in greater detail below in section 3.4 which includes a description of FIG. 7.

### 1.7 Component Model

The component model represents the code architecture elements at level of abstraction that is suitable for code architecture inference. The elements of the component model are the components and the relationships that make up the code architecture.

FIG. 4 depicts component model 400 and the data structures necessary to build the high level model. FIG. 4 is described with continued reference to the embodiment illustrated in FIG. 1. However, FIG. 4 is not limited to that embodiment. The high level model is the model representing the software source code at a pre-determined level of abstraction level. In an embodiment, the pre-determined level of abstraction used for the code architecture inference will match the level of abstraction used to define the planned architecture so that the code architecture can be compared to the planned architecture. FIG. 4 is an UML diagram illustrating the data structures needed to build a high level architecture model and also depicts as how the data structures are related to each other.

The most basic entity in architecture component model 400 is ArchElement 455. ArchElement 455 is derived from ArchModelElement 451 which is turn is extended by three entities: ArchComponentModel 459, ArchComponent 469, and ArchRelation 471.

ArchComponent 469 represents architecture component entities of the software system at a suitably high level of abstraction. For example client 105 and server 111 depicted in FIG. 1 each constitute a component such as ArchComponent 469. ArchComponent 469 is derived from ArchElement 455 via implementation inheritance 465. ArchComponentModel 459 is composed of Components 469 via compositions 463. According to an embodiment, the level of abstraction used to model architecture component entities of the ‘as built’ code architecture is the same level of abstraction used to model the planned architecture components, thus allowing the code architecture components to be readily compared to the planned architecture components.

Relation 471 is an entity that represents the relation between two components. For example, with continued reference to FIG. 1, method call 107 from FIG. 1 is a relation entity such as ArchRelation 471. Architectural relations contain an attribute called RelationType that specifies the relationship type, which reflects the kind of relation of the software system that it abstracts. For example, RelationType 467 may be a “Call_Relation” that reflects the type of relationship ArchRelation 471 has with ArchComponent 469. ArchRelations 471 are contained within components. More particularly, ArchRelation 471 is contained in ArchComponent 469 that is the origin of ArchRelation 471. The target component is only referenced in the relation. For example, ArchComponent 469 is referenced in ArchRelation 471. All components such as ArchComponent 469 know what relations they contain. ArchComponent 469 is derived from ArchElement 455 via implementation inheritance 475.

ArchComponentModel 459 is a container for architecture component ArchComponent 469 and ArchRelation 471. Architecture component model ArchComponentModel 459 represents a part of or the entire source code architecture of the software system in a hierarchical fashion. ArchComponentModel 459 is derived from ArchElement 455 via implementation inheritance 457.

### 1.8 File System Model

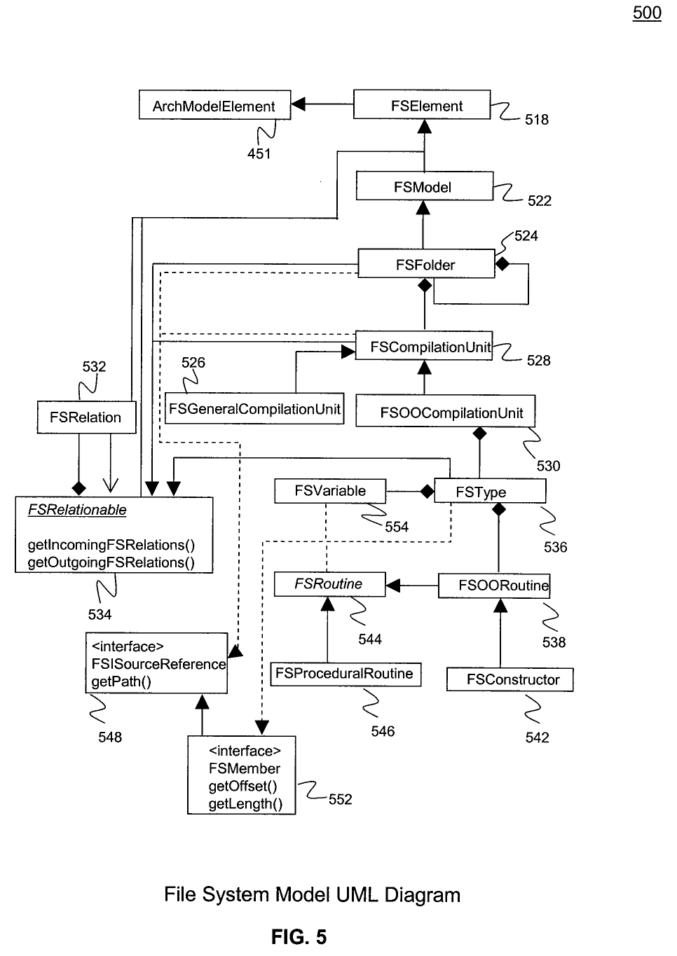

The file system model represents the dependencies between the file system units where each file system unit (files and/or directories) are characterized by its fully qualified location on the storage device). The elements of the file system model are these file system units and the relations between them. The file system model is described in greater detail below in the description of FIG. 5.

FIG. 5 is a UML diagram depicting the structure of File System model 500. FIG. 5 is described with continued reference to the embodiments illustrated in FIGS. 1 and 4. However, FIG. 5 is not limited to those embodiments.

File system model 500 is a representation of an analyzed software system at an abstraction level very close to the source code of the software system and the division of the source code into directories (folders) and files in the operating system. The most basic entity of file system model 500 is FSElement 518 that extends the more general ArchModelElement 451. In turn, FSElement 518 is extended by FSModel 522 and FSRelation 532.

According to an embodiment of the present invention, abstraction level used to model source code directories (folders) and files of the ‘as built’ code architecture is the same abstraction level used to model the planned architecture directories and files, thus allowing the code architecture directories and files to be readily compared to the planned architecture directories and files.

FSModel 522 is a collection of FSFolders 524. FSFolder 524 is analogous to ArchComponent 469 from component model 400. FSModel 522 constitutes a representation of all relevant parts of the analyzed software system.

According to an embodiment of the present invention, FSFolder 524 represents a directory or folder. According to another embodiment, when a software system is written in an object-oriented language such as Java, FSFolder 524 can represent a Java package. FSFolder 524 can contain other FSFolders to represent a nested directory structure with subdirectories. FSFolder 525 or FSCompilationUnits 528.

FSCompilationUnit 528 is a file containing code. In accordance with an embodiment, FSCompilationUnit 528 represents a compilation unit such as a Java object-oriented source file, a .cpp source code file in the C++ procedural programming language context, or a .c file in the C procedural programming language context. Multiple FSCompilationUnits 528 may be contained within an FSFolder 524.

FSOOCompilationUnit 530 is an entity that extends from or inherits from the more general FSCompilationUnit 528 to provide support for object-oriented code. FSOOCompilationUnit 530 is a fragment of object-oriented code, derived from the more general FSCompilationUnit 528. An FSOOCompilationUnit may contain one or more FSTypes 536. FSTypes 536 are classes and interfaces.

Similarly, FSGeneralCompilationUnit 526 is an entity that extends from FSCompilationUnit 528 to provide support for procedural language code (i.e., the C and FORTRAN programming languages). FSGeneralCompilationUnit 526 is a fragment of procedural code, derived from FSCompilationUnit 528. Since procedural code does not have classes or interfaces, procedural language code is interpreted as a collection of FSProceduralRoutines 546.

FSType 536 represents an object oriented type such as a class or an interface and can contain FSVariables 554 or FSOORoutines 538.

FSRoutine 538 forms the base class of routines in FSModel 522. It is extended by FSProceduralRoutine 546. FSProceduralRoutine 546 represents a routine in a procedural language.

FSOORoutine 538 represents a routine or method in an object-oriented language like Java. FSOORoutine 538 represents a function, procedure or method in an object oriented context and extends FSRoutine 544. FSOORoutine 538 is contained in FSOOCompilationUnit 530.

FSConstructor 542 is a special type of FSOORoutine 538 and represents a constructor of a class.

FSProceduralRoutine 546 represents a function or procedure of a non object oriented programming language and extends FSRoutine 544. FSProceduralRoutine 546 is contained in FSGeneralCompilationUnit 526.

FSVariable 554 represents a variable or member of the context being specified by the element that contains FSVariable 554. The element containing FSVariable 554 can be either FSGeneralCompilationUnit 526 or a file system type such as FSType 536.

To reflect relations between entities in the software system such as calls, imports, or accesses there has to be a connection between FSModel 522 elements. This connection is achieved by FSRelation 532. Like ArchRelation 471 in component model 400 depicted in FIG. 4, FSRelation 532 is capable of representing various types of relations and is contained in the element that is the source of the relation. The ability to build such a connection is inherited by FSRelationable 534, which extends the FSFolder 524 base class.

FSISourceReference 548 is an interface that is implemented by FSFolder 524 and FSCompilationUnit 528. As a result of this inheritance, each FSFolder 524 and FSCompilationUnit 528 stores the full file path information. Similarly, as the FSIMember 552 interface is implemented by FSVariable 554, FSRoutine 544, and FSType 536, each of these elements and their subclasses store offset and length information. Offset information indicates where in a source code file the corresponding code element is located and length information indicates how long, in bytes, the corresponding code element in the source code file is. Offset and length information is needed in order to be able to link the exact file offset in which an architectural relation is created to its corresponding representation in the core model.

### 1.9 Architecture File System Connector Model

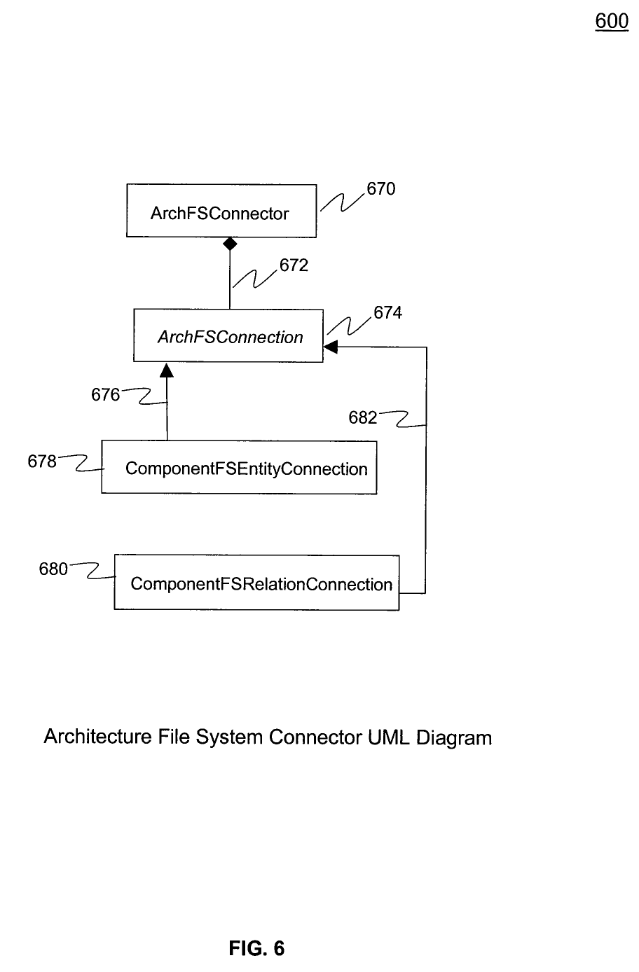

The Architecture File System Connector model (ArchFS) model connects the File System depicted in FIG. 5 with the Component Model depicted in FIG. 4. The ArchFS models the explicit relationships and connections between the software architecture elements and the file system elements. The ArchFS model is described in greater detail below in the description of FIG. 6.

FIG. 6 is a UML diagram depicting the structure of ArchFS model 600. FIG. 6 is described with continued reference to the embodiments illustrated in FIGS. 4 and 5. However, FIG. 6 is not limited to those embodiments.

According to an embodiment of the present invention, ArchFSConnector 670 bridges the gap between component model 400 and file system model 500 depicted in FIGS. 4 and 5, respectively. ArchFSConnector 670 bridges the gap between these two models by building references from every ArchElement 455 from component model 400 to a plurality of FSElements 518 from file system model 500. Thus, the information that can be extracted from these explicit relationships includes the file system model elements that are represented by elements in the high level model. According to an embodiment ArchFSConnector 670 is a collection of ArchFSConnections 674 which are responsible for capturing the relationships between ArchElement 455 and FSElements 518. ArchFSConnections 674 are collected by ArchFSConnector 670 via composition 672.

FSEntityConnection 678 and ComponentFSRelationConnection 680 are both derived from the more general ArchFSConnection 674. ComponentFSEntityConnection 678 captures the connections between the entities in component model 400 with the corresponding entities in FSModel 522 of file system model 500. ComponentFSEntityConnection 678 is derived from ArchFSConnection 674 via implementation inheritance 676. Similarly, ComponentFSRelationConnection 680 captures the relationships between the entities in the component model 400 with corresponding entities in FSModel 522. ComponentFSRelationConnection 680 is derived from ArchFSConnection 674 via implementation inheritance 682.

### 1.10 The Core Model

FIG. 7 integrates FIGS. 4-6 to provide a UML diagram of the entire core model 700. FIG. 7 is described with continued reference to the embodiments illustrated in FIGS. 4-6. However, FIG. 7 is not limited to those embodiments.

FIG. 7 illustrates how ArchElement 455 of component model 400, FSElement 518 of file system model 500, and ArchFSConnector 670 of ArchFS model 600 all inherit from ArchModelElement 451. FIG. 7 also contains additional model elements that are common to all 3 models or concept spaces depicted in FIGS. 4-6.

Project 716 contains one or more Packages 798. Each Package 798 is a collection of ArchComponentModels 459, ArchFSConnectors 670 of ArchFS model 600, and FSModels 522. According to an embodiment of the invention, the architecture extraction process builds up Package 798.

### 2.0 Operational Embodiments

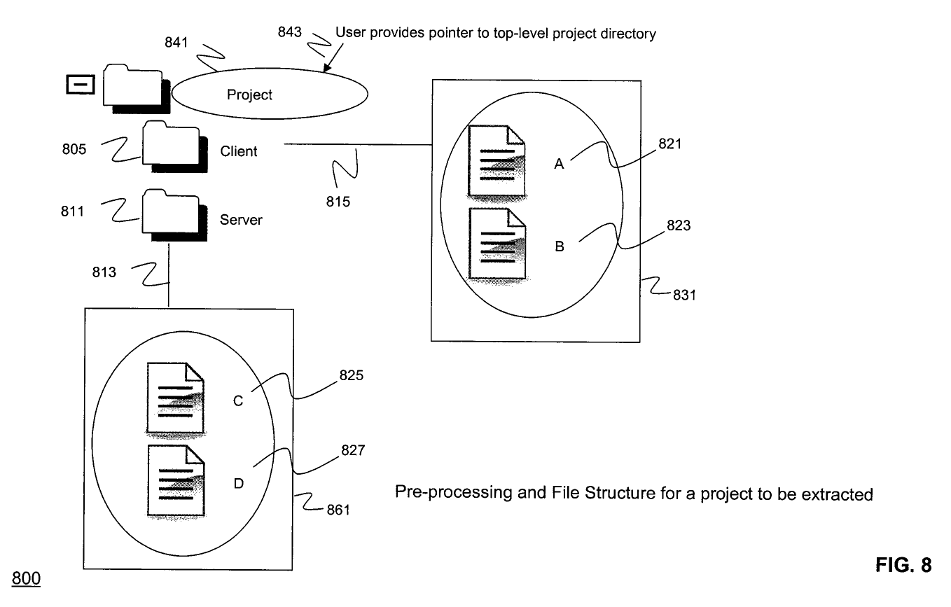

FIG. 8 illustrates pre-processing 800 that occurs prior to the process of parsing the source code and building a package. FIG. 8 is described with continued reference to the embodiment illustrated in FIG. 7. However, FIG. 8 is not limited to that embodiment.

Pre-processing 800 occurs prior to parsing source code of a software system and building a package such as Package 798 depicted in FIG. 7.

Pre-processing 800 involves gathering pre-processing information, starting with the project name. The process needs to know the project 841 with which Package 798 that is to be built is to be associated with. Project 841 may already be a pre-existing project or may be a new project created to store the result of the architecture extraction process.

Top-level directory location 843 is provided by a user in order to locate the project directory where the project's source code is kept. According to an embodiment of the invention, a user is prompted to supply a pointer to the top-level project directory location 843.

Client 805 has link 815 to top level directory 831. Client 805 is the name of a directory which contains two files, A 821 and B 823. FIG. 8 illustrates the directory structure for a project with client 805 and server 811. According to an embodiment, a user may select top-level directory 831 structure as a starting point for where analysis will begin. Top level directory 831 is comprised of files. The files within top level directory 831 are files 821 and 823. Server 811 has link 813 to top level directory 861, which is comprised of files 825 and 827.

### 2.1 Component Modeling Strategies

According to an embodiment of the present invention, two alternative component definition strategies, folder-based and file-based, are provided. The folder-based or file-based component definition strategies can be followed to create component model 400 depicted in FIG. 4. Each of these two strategies relates to what code elements from a file system will be associated with the lowest level component (i.e., a folder/directory or a file). For both strategies, the lowest level component is the component that has no sub-component or code element nested within or below it.

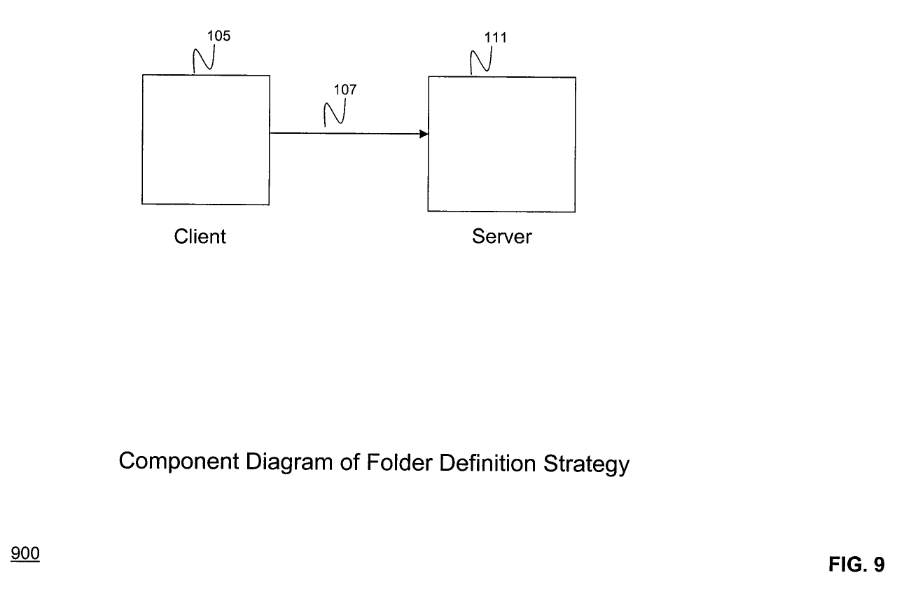

FIG. 9 illustrates the components for the project depicted in FIG. 8 when using the folder-based component definition strategy 800. The folder-based component definition strategy 800 is useful to infer, model, and display architectures of large software systems. FIG. 9 is described with continued reference to the embodiment illustrated in FIG. 8. However, FIG. 9 is not limited to that embodiment.

According to an embodiment of the present invention, the lowest level component modeled is a folder or directory. Folder-based component definition strategy 900 is useful for large software systems as the lowest level components defined are relatively high-level folders. In accordance with an embodiment, strategy 900 has just two components client 105 and server 111. Client 105 and server 111, correspond to client folder 805 and server folder 811, respectively. In an embodiment, the folder-based components of software systems may be represented by a graphical display of system components. The display may allow users to selectively depict portions or subsets of the software system architecture. The graphical depictions of different portions of system architecture may be displayed in split windows on a computer display screen, tiled in multiple sub-windows, or in list form.

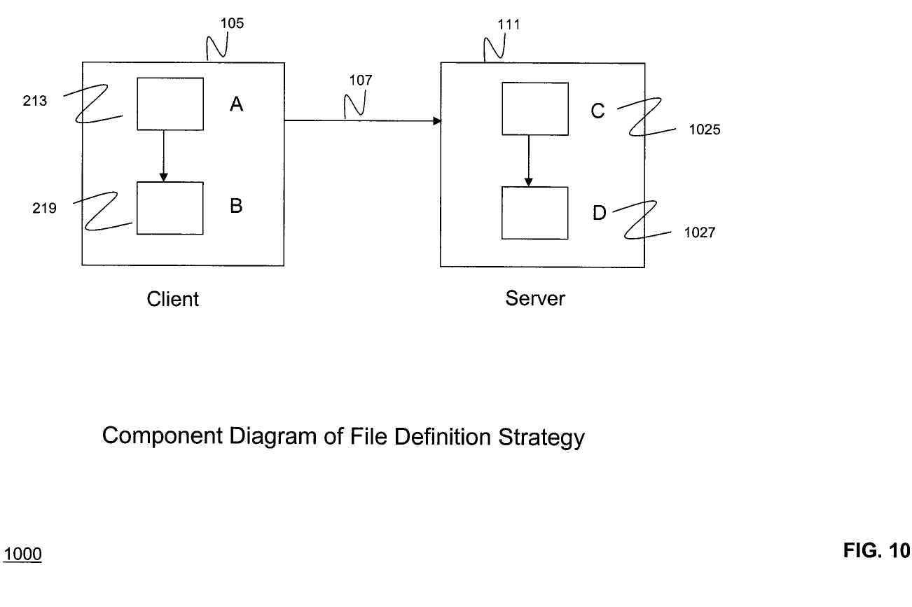

FIG. 10 illustrates the components for the project depicted in FIG. 8 when using file-based component definition strategy 1000. The file-based component definition strategy 1000 is useful to infer, model, and display architectures of small to medium software systems. FIG. 10 is described with continued reference to the embodiment illustrated in FIG. 8. However, FIG. 10 is not limited to that embodiment.

According to an embodiment of the invention, the lowest level component defined in the file definition strategy is a file. File-based component definition strategy 1000 is useful for smaller and medium sized software systems containing relatively few folders or directories.

The lowest level components are not the folders client 105 and server 111, but the files contained inside client 105 and server 111. Files 213 and 219 contained with client 105 are defined. Similarly, files 1025 and 1027 are defined within server 111. The A and B components (e.g., files 213 and 219) together constitute the client component 105. Similarly, components C and D (e.g., files 1025 and 1027) constitute server component 111. In an embodiment, the file-based components of a software system may be represented by a graphical display of the software system's components. The display may allow users to selectively depict portions or subsets of the software system architecture. The graphical depictions of different portions of software system architecture may be displayed in split windows on a computer display screen, tiled in multiple sub-windows, or in list form.

### 2.2 External Link Strategies

Software systems undergoing analysis may have coupling relationships with source code outside the boundaries of the software system being analyzed and modeled. For example, a software system whose architecture is being inferred may use libraries or other existing, external components. According to an embodiment of the present invention, the user is allowed to choose between two alternate strategies. In accordance with an embodiment, a user can choose to either consider or ignore links from a software system to external entities such as standard libraries. According to a strategy that calls for consideration of external links, a user chooses to take into account links to external entities.

If a user chooses to ignore external links, relationships with entities outside the boundary of the software system being analyzed are not created. Otherwise, the fact extractor includes external entities and their relations with the software system under analysis should be included in the core model.

### 2.3 Fact Extraction

According to an embodiment of the invention, after the strategies have been chosen by a user, the fact extraction process begins.

For each programming language, the responsibility fact extraction constructs packages such as Package 798 depicted in FIG. 7. Package 798 is constructed by traversing the parse tree for each software source code file. Package construction can be achieved with existing Open Source tools like CDT (for C language source code files) and JDT (for Java packages) that generate parse trees for input files and provide interfaces (‘visit interfaces’) for accessing the nodes of the parse trees. Tools such as CDT and JDT can be used to retrieve binding information for each node. Binding information is the language-specific meta-data (used for full name resolution) associated with each unit of code that is typically stored in a symbol table.

The fact extractor implements “visit” interfaces by specifying the series of actions it is supposed to perform every time it visits a particular type of an Abstract Syntax Tree (AST) node. The type of an AST node depends on the software statement it represents: a method call, a variable declaration etc.

### 2.4 Visit Interface Method

According to an embodiment of the invention, the Visit Interface method gathers information for each implemented visit. The Visit Interface method completes the steps described in the following sections in order to obtain binding information, create component and relation elements, construct file system component (FSComponent), and construct file system relation (FSRelation) elements.

### 2.4.1 Obtain Bindings

The first step of the Visit Interface method is to obtain full information (bindings) for each of the programming constructs referred to in the AST node under consideration.

### 2.4.2 Create Component and Architectural Relation Elements

Based on the bindings obtained as described in section 2.4.1 above, combined with the selected component association and software system boundary strategies described above, component and architectural relation type elements are created. Component and ArchRelation elements are created such as ArchComponent 469, and ArchRelation 471 depicted in FIG. 4.

### 2.4.3 Create FSComponent and FSRelation Elements

Based on the bindings, component association strategy, and the software system boundary choices; elements of type FSComponent and FSRelation are created such as FSRelation 532 depicted in FIG. 5.

### 2.4.4 Construct Component to File System-Entity Relations/Connections

Next, the component to file system entity (ComponentFSEntityConnection) and component to file system relation connections (ComponentFSRelationConnection) such as ComponentFSEntityConnection 678 and ComponentFSRelationConnection 680 depicted in FIG. 6 are constructed. The ComponentFSEntityConnections and ComponentFSRelationConnections are constructed as relationships between the entities and models constructed in steps 2.4.2 and 2.4.3 above.

### 3. Example Implementation of Fact Extraction for Code Architecture

In the subsequent discussion, an example fact extractor for the Java programming language is described. According to an embodiment of the invention, the fact extractor uses the Abstract Syntax Tree (AST) representation of the code obtained through the component ASTParser of the Java Development Kit (JDT).

The Java Development Tools described herein are part of the Eclipse SDK and contain the subprojects JDT APT, JDT Core, JDT Debug, and JDT UI. The JDT Core project provides a tool which allows for extraction of relevant facts from java projects. The ASTParser builds up a syntax tree which means that for every relevant fact, a node is generated which has exactly one parent and one or more children. By using ASTVisitor, the visitor interface offered by the AST, this tree can be traversed recursively.

The following steps are followed during the fact extraction process, according to an embodiment of the invention:

1. A new parser object is created
2. A source is specified which in this case is a compilation unit (i.e., a Java file).
3. The parser object generates the abstract syntax tree.
4. The recursive traversing of the tree is initiated. Depending on the type of the AST node (whether it represents a method invocation, an import, a class instance creation etc) that is being visited, a relevant method is called (through overloading based on ASTNode type) which then processes the ASTNode and constructs the corresponding core model.
The general structure of a java file is as follows:

```
import package.class.*;
class MainClass
{
  Variable Declarations
  // Default Constructor
  public MainClass( )
  {
    // Body
  }
  // Method (void denotes return type)
  void Method( )
  {
    // variables
    int var1
    int var2
    ...
  }
  // Inner Class
  class InnerClass
  {
    // Methods, Variables, etc.
  }
//Initializer
{
}
}
```

The section below describes how different kinds of ASTNodes are processed in accordance with an embodiment of the invention. Standard Java comments are used to annotate the pseudo-code below.

Case 1: ASTNode is of type InstanceCreation
ASTNode has form:

```
    X= new C( ); where X is referred to as the “creator” and C is the
  “instance.” For example, this statement calls the constructor of C and stores
  the reference to object C in X.
  1. binding information for type C is obtained and stored as the instance type binding
  2. binding information for constructor C is obtained and stored as the instance
  constructor binding
  // As new C( ) denotes both a dependency to the class C and a call to the
  constructor C, two bindings are created in Lines 1 and 2 above to store the
  class and constructor binding
  3. parent of current ASTNode is obtained
  4. while (a parent exists) {
  5. if parent is a method declaration.
  6. binding information for parent is obtained and stored as creator binding
and occurs_in_method is set to true
  7. if parent is an initializer block and parent of parent is a class or
interface definition
  8. binding information for parent is obtained and stored as creator binding
  and initializer is set to true
  9. the AST tree is navigated upwards by getting the parent of current
  node
  }
  // In lines 3 to 9 above, the code seeks to determine in what context the creator
  occurs (i.e., determine whether it occurs in an initializer or inside a method).
  In order to do this, the AST is navigated upwards until the context of the
  creator is found or until the root of the AST is reached.
  10. CreatorComponent of type Component is created using creator
  binding, the chosen component definition strategy
  11. InstanceComponent of type Component is created using instance type
  binding, the chosen component definition strategy and the choice taken (i.e.,
  ignore or take into account external links) during the External Links selection
  12. an access relation of type Relation between CreatorComponent and
  InstanceComponent is created
  13. a call relation of type Relation between CreatorComponent and
  InstanceComponent is created
  // In lines 10-13 above the entities in the ArchComponentModel are created.
  Two relations are created to take into account both the fact that a class defined
  elsewhere has been used and that a constructor from another component has
  been called
  14. an instanceFSType of type FSType is created using instance type
  binding and the choice taken (i.e., ignore or take into account external links)
  during the External Links selection
  15. an instanceFSConstructor of type FSConstructor is created using
  instance constructor binding and the choice taken (i.e., ignore or take into
  account external links) during the External Links selection
  //In lines 14 and 15, population of the FSModel is initiated. An object of type
  FSType and an object of type FSConstructor are created, taking into account if
  the instance is created inside or outside the boundaries of the analyzed
  software system and whether the user is interested in couplings to external
  entities
  16. the offset and length of the creator in the source file is obtained
  //This is done so that the exact file position corresponding to the creator is
  obtained which in turn enables navigability from the architecture to code
  17. If initializer=true
  18. creatorFS of type FSType using creator binding, offset and length is
  created
  19. else if occurs_in_method=true and parent in AST tree is a
  MethodDeclaration
  20. creatorFS of type FSConstructor is created using
  creator binding, offset, and length
  21. else creatorFS of type FSOORoutine is created using creator
  binding, offset, and length
  22. UniqueFSRelation between creatorFS and instanceFSType of type
  “access relation” is created
  23. UniqueFSRelation between creatorFS and instanceFSConstructor of
  type “call relation” is created
  //Depending on whether the context in which the creator occurs (initializer,
  constructor, or method) an appropriate FSModel component is constructed and
  two FSRelations, if they do not exist already, are generated.
```

Case II: ASTNode is of type ImportDeclaration i.e., of form:

import C; where the compilation unit where this statement occurs
is the importer and C is the importee
1. binding information for importee is obtained and stored as the
importee binding
2. ImporterComponent of type Component is created using the
compilation unit in which the importer occurs and the chosen component
definition strategy
3. ImporteeComponent of type Component is created using importee
binding and the chosen component definition strategy and the choice taken
(i.e., ignore or take into account external links) during the External Links
selection
4. an import relation of type Relation between ImporterComponent and
ImporteeComponent is created
5. importerFSCompUnit of type FSOOCompilationUnit is created using
the compilation unit in which the statement occurs
6. importeeFSType of type FSType is created using the importee binding
and the choice taken (i.e., ignore or take into account external links)
during the External Links selection
7. UniqueFSRelation between importerFSCompUnit and
importeeFSType of type “import relation” is created

Case 3: ASTNode is of type MethodInvocation i.e., of form:

```
    C( ); where C is referred to as the “callee” and the compilation unit
where the above statement occurs is referred to as the “caller.”
1. binding information for callee is obtained and stored as the callee
binding
2. parent of current ASTNode is obtained
3. while (parent is not null) {
4. if parent is a method declaration
5. binding information for parent is obtained and stored as
        the caller binding and occurs_in_method is set to true
6. if parent is an initializer block and parent of parent is a class or
interface definition
7. binding information for parent is obtained and stored as the
      caller binding and initializer is set to true
8. the AST tree is navigated upwards by getting the parent of current
node
}
9. CalleeComponent of type Component is created using callee binding,
the chosen component definition strategy and the choice taken (i.e., ignore
or take into account external links) during the External Links selection
10. CallerComponent of type Component is created using caller binding
and the chosen component definition strategy
11. a call relation of type Relation between CallerComponent and
CalleeComponent is created
12. calleeFSRoutine of type FSOORoutine is created using callee binding
and the choice taken (i.e., ignore or take into account external links)
during the External Links selection
13. the offset and length in the source file of the caller is obtained
14. If initializer=true
15. callerFSElement of type FSType using caller binding, offset
      and length is created
16. else if occurs_in_method=true and parent in AST tree is a
    MethodDeclaration
17. callerFSElement of type FSConstructor is created using caller
      binding, offset and length
18. else callerFS of type FSOORoutine is created using caller binding,
    offset, and length
19. UniqueFSRelation between callerFSElement and calleeFSRoutine of
type “call relation” is created
```

Case 4: ASTNode is of type SuperMethodInvocation (i.e., of form):

```
    super(parameters); where the submethod invokes the supermethod
1. binding information for supermethod is obtained and stored as the
supermethod binding
2. parent of current ASTNode is obtained
3. while (parent is not null) {
4. if parent is a method declaration.
5. binding information for parent is obtained and stored as the
      submethod binding and occurs_in_method is set to true
6. if parent is an initializer block and parent of parent is a class or
interface definition
7. binding information for parent is obtained and stored as the
submethod binding and initializer is set to true
8. the AST tree is navigated upwards by getting the parent of current
    node
}
9. SupermethodComponent of type Component is created using
supermethod binding, the chosen component definition strategy and the
choice taken (i.e., ignore or take into account external links) during the
External Links selection
10. SubmethodComponent of type Component is created using
submethod binding and the chosen component definition strategy
11. a call relation of type Relation between SubmethodComponent and
SupermethodComponent is created
12. supermethodFSRoutine of type FSOORoutine is created using
supermethod binding and the choice taken (i.e., ignore or take into account
external links) during the External Links selection
13. the offset and length in the source file of the submethod is obtained
14. If initializer=true
15. submethodFSElement of type FSType using submethod
      binding, offset and length is created
16. else if occurs_in_method=true and parent in AST tree is a
    Methoddeclaration
17. submethodFSElement of type FSConstructor is created using
      submethod binding, offset and length
18. else submethodFSElement of type FSOORoutine is created using
    submethod binding, offset and length
19. UniqueFSRelation between submethodFSElement and
supermethodFSRoutine of type “call relation” is created
```

Case 5: ASTNode is of type TypeDeclaration i.e., a class or an interface has been defined

1. If there exists a superclass for the current ASTNode {
2. binding information of the ASTNode type (class or interface) is obtained and
stored as subclass binding
3. binding information for the superclass of the ASTNode is obtained and stored
as the superclass binding
}
4. SuperclassComponent of type Component is created using superclass
binding, the chosen component definition strategy and the choice taken (i.e.,
ignore or take into account external links) during the External Links selection
5. SubclassComponent of type Component is created using subclass
binding and the chosen component definition strategy
6. an inheritance relation of type Relation between
SubmethodComponent and SupermethodComponent is created
7. superclassFSType of type FSType is created using the superclass
binding and the choice taken (i.e., ignore or take into account external links)
during the External Links selection
8. the offset and length in the source file of the subclass is obtained
9. subclassFSType of type FSType is created using the subclass binding
and the choice taken (i.e., ignore or take into account external links) during the
External Links selection
10. UniqueFSRelation between superclassFSType and subclassFSType of
type “inheritance relation” is created
11. If there exists an interface that the current ASTNode implements {
12. for each such interface {
13. binding information of the ASTNode type is obtained and stored as type binding
14. binding information for the interface the ASTNode implements
is obtained and stored as the interface binding
15. InterfaceComponent of type Component is created using interface
binding, the chosen component definition strategy and the choice taken (i.e.,
ignore or take into account external links) during the External Links selection
16. TypeComponent of type Component is created using subclass binding
and the chosen component definition strategy
17. an interface relation of type Relation between TypeComponent and
InterfaceComponent is created
18. interfaceFSType of type FSType is created using the interface binding and the
choice taken (i.e., ignore or take into account external links) during the
External Links selection
19. the offset and length in the source file of the type is obtained
20. typeFSType of type FSType is created using the subclass binding and
the choice taken (i.e., ignore or take into account external links) during the
External Links selection
21. UniqueFSRelation between interfaceFSType and type FSType of type
“interface relation” is created
}

Case 6: The ASTNode is of type SingleVariableDeclaration i.e., represents formal parameter lists (field declarations and regular variable declarations are not considered as they do not define architectural relations).
The ASTNode is of the form <T varname> where T represents the type and varname is the name of the variable.

```
1. if the variable is an array, the binding of any one of its elements is
stored as type binding else obtain the binding information associated
with “T” and store it as type binding.
2. if the variable is not a primitive type {
// a primitive type are the types supported natively by the programming
language
3. parent of current ASTNode is obtained
4. while (parent is not null) {
5. if parent is a method declaration.
6. binding information for parent is obtained and stored as
        the method binding and occurs_in_method is set to
      true
7. if parent is an initializer block and parent of parent is a class or
interface definition
8. binding information for parent is obtained and stored as the
      method binding and initializer is set to true
9. the AST tree is navigated upwards by getting the parent of current
node
}
//In lines 3 to 9 above, the algorithm tries to understand where the method
in whose parameter list the variable occurs, is located
10. TypeComponent of type Component is created using type binding, the
chosen component definition strategy and the choice taken (i.e., ignore or
take into account external links) during the External Links selection
11. MethodComponent of type Component is created using method
binding and the chosen component definition strategy
12. an access relation of type Relation between TypeComponent and
MethodComponent is created
13. TypeFSType of type FSType is created using type binding and the
choice taken (i.e., ignore or take into account external links) during the
External Links selection
14. the offset and length in the source file of the parent (method or
initializer as identified in the loop that spans line 4 to 9) is obtained
15. If initializer=true
16. methodFSElement of type FSType using method binding,
offset and length is created
16. else if occurs_in_method=true and parent in AST tree is a
    Methoddeclaration
17. methodFSElement of type FSConstructor is created using
method binding, offset and length
18. else methodFSElement of type FSOORoutine is created using
    method binding, offset and length
19. UniqueFSRelation between TypeFSType and methodFSElement of
type “access relation” is created
```

### 4. Architectural Evaluation Processes and Methods

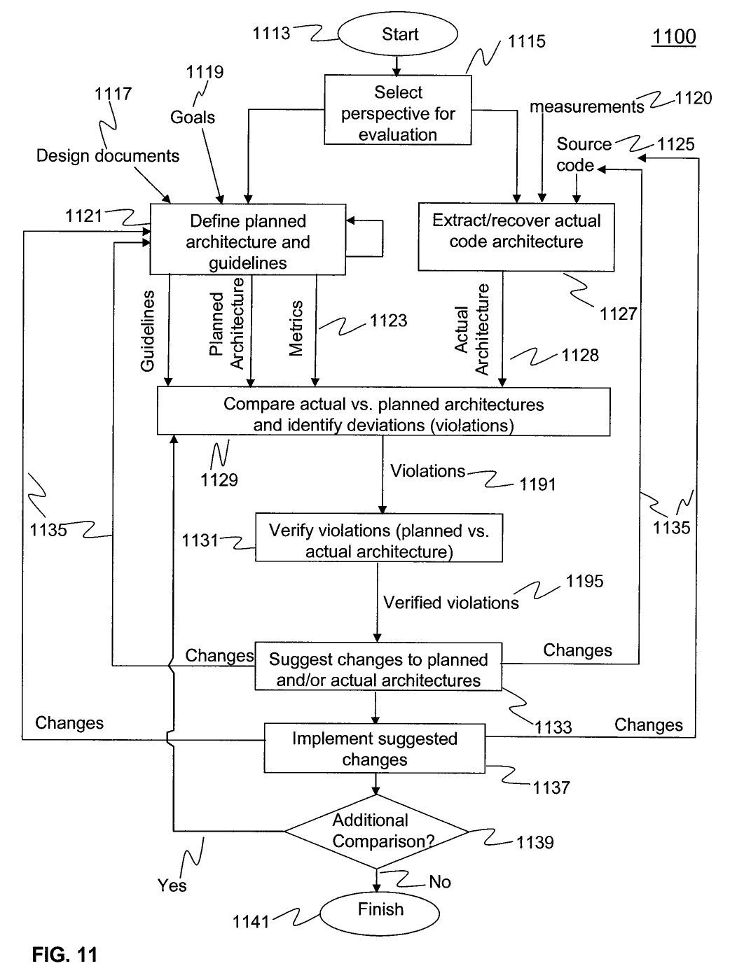

FIG. 11 illustrates the architectural evaluation process 1100. The architectural evaluation process includes defining and documenting the planned architecture, comparing the planned and actual architectures, and subsequently evaluating each deviation between the architectures. Architectural evaluation process 100 may be implemented in numerous ways, including as a method, a system comprising modules configured to perform the process steps, and as a computer program product comprising a computer usable medium having computer program logic recorded thereon for enabling a processor to perform the process steps. The following description of each step includes information regarding the roles of software development and analysis teams. According to an embodiment, the method can be tailored for different contexts or software development environments by employing different metrics.

The method begins at step 1113 and continues with step 1115 when a perspective for evaluation is selected.

Selecting a perspective in step 1115 identifies goals 1119 and measurements 1120 for architectural evaluation process 1100. Selecting a perspective in step 1115 is important to identify appropriate goals and measurements for evaluation method 1100. According to an embodiment of the invention, the Goal, Question, Metric (GQM) technique can used in step 1115 to define goal-oriented metrics based on questions that need to be answered to determine if goals 1119 have been achieved. For example, if the selected perspective stresses maintainability, goals based maintainability attributes such as coupling and cohesion will be identified.

An analysis team may perform step 1115 with the help of a software development team, wherein the development team provides input on the selected perspective. The perspective selected in step 1115 drives the extraction of the actual architecture in step 1127 as well as the definition of the planned architecture in step 1121. The analysis team creates the goals and defines the metrics following the Goal, Question, Metric (GQM) technique, according to an embodiment. The development team provides feedback to the analysis team on the goals and metrics.

In step 1121, the planned architecture and guidelines are defined. For example, goals may be identified and elaborated using the GQM technique in this step. The planned architecture of the software system is identified and guidelines with associated metrics are defined in step 1121. These architectural guidelines are used to validate that the architecture possesses desired properties according to the perspective selected in step 1115.

The planned architecture defined in this step correlates to the software code architecture that was part of the planned software system design. The software system design documents 1117 and specifications may be used in this step to define the software system's planned architecture.

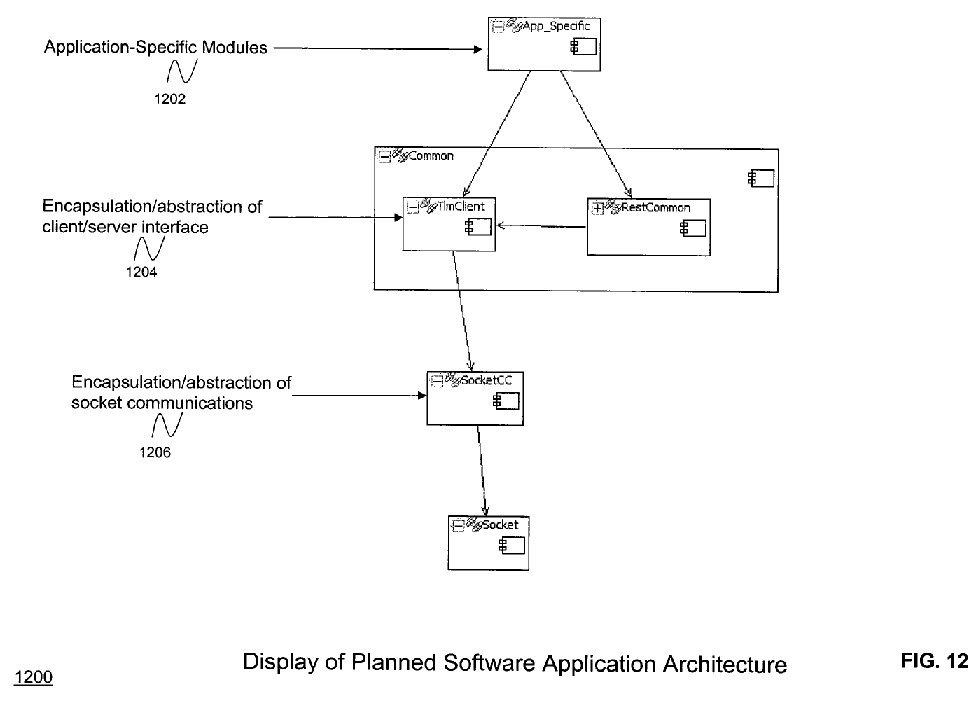

In an embodiment, the planned architecture is graphically depicted as a result of performing step 1121. FIG. 12 provides an exemplary graphical display 1200 of a planned architecture, in accordance with an embodiment of the present invention. Display 1200 is a result of step 1121 that allows an analysis team to visually specify the planned architecture. As depicted in FIG. 12, application-specific modules 1202 may be displayed in display 1200. Display 1200 may also depict the encapsulation or abstraction of client/server interface 1204 and of socket communications 1206.

The architecture guidelines defined in this step may be used to determine if the architecture possesses desired properties. The planned architecture and guidelines are defined in this step in order to compare the ‘as designed’ architecture with the actual or ‘as built’ architecture. The comparison in step 1129 (described in further detail below) is performed to determine if there is need to modify the software system code to bring it into closer alignment with the planned architecture defined in step 1121.

After a perspective has been chosen and goals have been identified in step 1115, the planned architecture of the software system is identified and guidelines with associated metrics are defined in step 1121. Architectural guidelines are used to validate that the architecture possesses desired properties. According to an embodiment, these guidelines translate into quantitative metrics 1123. Quantitative metrics 1123 include measured coupling between components. The extent of the coupling is derived from these guidelines. For example, quantitative metrics 1123 include the number of couplings between components and that information is used in this step to evaluate maintainability of the architecture. In addition to defining guidelines and metrics 1123 based on the perspective of the architectural evaluation selected in step 1115, some guidelines and metrics 1123 are defined based on the architectural styles and the design patterns chosen for the software system in step 1121.

According to an embodiment, once the planned architecture of the software system has been defined in step 1121, an analysis team uses it to derive the implications in terms of evaluation guidelines. The analysis team selects and customizes the guidelines and metrics 1123 for the specific context. The selected set of metrics 1123 must capture the properties that are important to the team while also being cost-efficient to collect and analyze. As the analysis team learns more about the planned or designed software architecture, these guidelines and metrics 1123 can be repeated and updated during multiple iterations of step 1121.

Quantitative metrics measuring coupling between the components and the extent of the coupling are derived from these guidelines. In addition to defining guidelines and metrics based on the perspective of the architectural evaluation selected in step 1115, some guidelines and metrics are defined based on the architectural styles and the design patterns that are chosen for the software system in step 1121. Architectural guidelines are used to validate that the architecture possesses desired properties. According to an embodiment, these guidelines translate into quantitative metrics 1123. For example, if evaluating a software system from the perspective of maintainability, guidelines related to coupling are established. Sample guidelines based on coupling might include one of attempting to keep coupling between the components low or attempting to keep the extent of coupling between components low. Quantitative metrics may include measured coupling between components, wherein the extent of the coupling is derived from the guidelines defined in this step. Quantitative metrics may include the number of couplings between components and that information is used to evaluate maintainability of the architecture.

The analysis team may work with one or more representatives of the development team (and/or uses software system documentation) to identify the planned architecture of the software system. The planned (or ideal/intended) software architecture is defined by architectural requirements, by implicit and explicit architectural guidelines, and by design rules and implications stemming from the use of architectural styles and design patterns. The analysis team may recover different aspects of the planned architecture and creates a model of it that will guide the evaluation. Once the high level architecture of the software system has been defined, the analysis team may use it to derive the implications in terms of evaluation guidelines that result. The analysis team may select and customize the guidelines and metrics for the specific context. The selected set of metrics must capture the properties that the team finds most important while, at the same time, being cost-efficient to collect and analyze. As the analysis team learns more about the planned architecture, these guidelines and metrics can be repeated and updated during multiple iterations of step 1121. The need for repeated definitions of the planned architecture and guidelines in step 1121 is determined by the analysis and development teams, according to an embodiment.

In step 1127, the actual code architecture is extracted or recovered from source code 1125 of the software system. As discussed in previous sections, the code architecture extraction (or fact extraction) may be performed by constructing a core model, which maintains explicit relationships between the core model and the original source code. The actual architecture of the software system, which is largely an abstraction obtained from the source code, represents the implementation of the software system.

Step 1127 is not the same as source code analysis, but it is used to identify the static architectural components of an actual software system. In an embodiment, the abstraction level of the architectural components of the implemented software system is the same as the abstraction level used to define the planned architecture of the software system in step 1121, making comparison of the planned architecture and the actual more efficient.

To perform step 1127 efficiently, an analysis team may rely on a set of automated or partially automated tools that assist with this task, according to an embodiment. The tools are defined based on the software programming language, the measurements that are to be collected, and other factors in the development environment, in accordance with an embodiment. Identifying what constitutes a component is often one of the key complications involved with the recovery of the high-level architecture of an implemented software system. In some cases, programming language features can be used to reduce some of the difficulties associated with this task. For example, if the programming language is Java, the analysis team can use packages as a way of determining the contents of the software system's components. Not all Java developers use packages and even when packages are used, there is not always a one-to one correspondence between the packages and the high-level components of a software system written in the Java programming language.

Identifying architectural styles and design patterns is another complication that arises with the recovery of the actual architecture in step 1127. Architectural styles are not always easy to detect in the actual implementation of a software system. Design patterns can be implemented in different ways and can be difficult to detect.

As part of step 1127, a software design team may work with one or two members of the software development team to partition the files containing the actual implementation of the software system into their appropriate components. Then, the analysis team extracts relevant information and computes metrics from the component files to obtain the actual architecture of the software system.

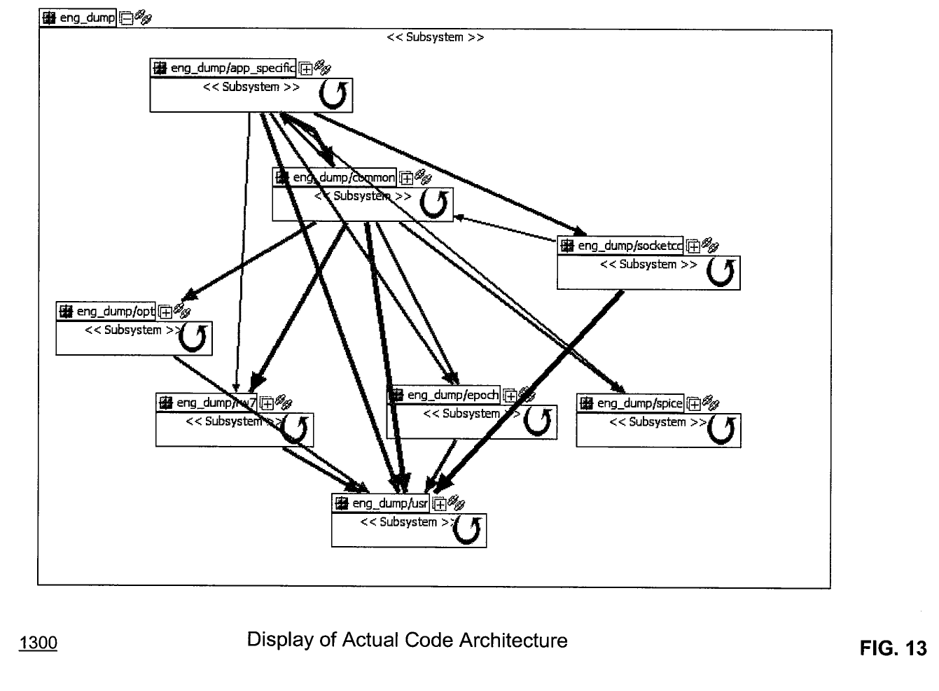

The actual code architecture recovered in step 1127 is the high-level structure of the current ‘as built’ implemented software system, its architectural components and their interrelationships, as well as its architectural styles and design patterns. For example, the core model may contain the main data structures for building the model of source code 1125. In an embodiment, the actual code architecture is graphically depicted as a result of performing step 1127. FIG. 13 depicts a graphical display 1300 of an actual code architecture, in accordance with an embodiment of the present invention.

As discussed above, the core model can be split into three different concept spaces: the component model, the file system model, and the file system connector model. Once extracted, actual architecture 1127 is made available for use in the next step of the process.

In step 1129 of the process, actual architecture 1127 and the planned architecture defined in step 1121 are compared to identify architectural deviations between the design and the actual, or ‘as built’ software system. Architectural deviations identified in step 1129 are differences between the planned architecture and the actual implemented version of the architecture. Architectural differences or deviations are referred to as ‘violations.’ Violations 1191 are identified in step 1129 by comparing the planned architectural design defined to the abstraction of actual architecture 1128 obtained in step 1127, wherein the abstraction levels of the planned and code architectures match.

Violations 1191 identified in step 1129 are differences between the planned architecture and the actual implemented version of the architecture 1127. Violations 1191 can be missing or extra components, missing or extra connections between components, violations of architectural guidelines, or values of metrics that exceed or do not match an expected value.

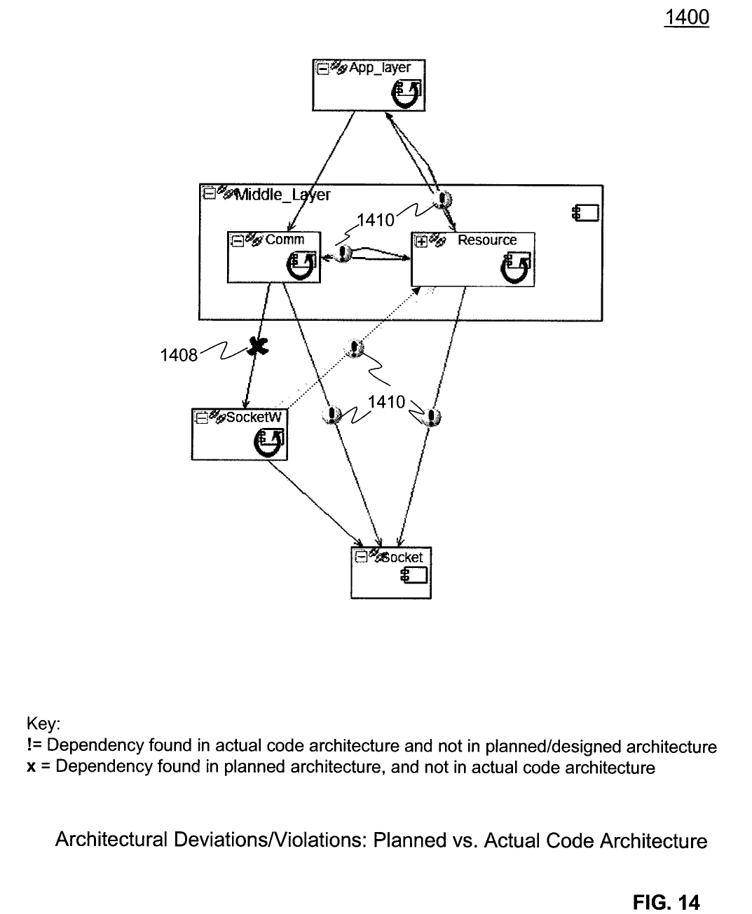

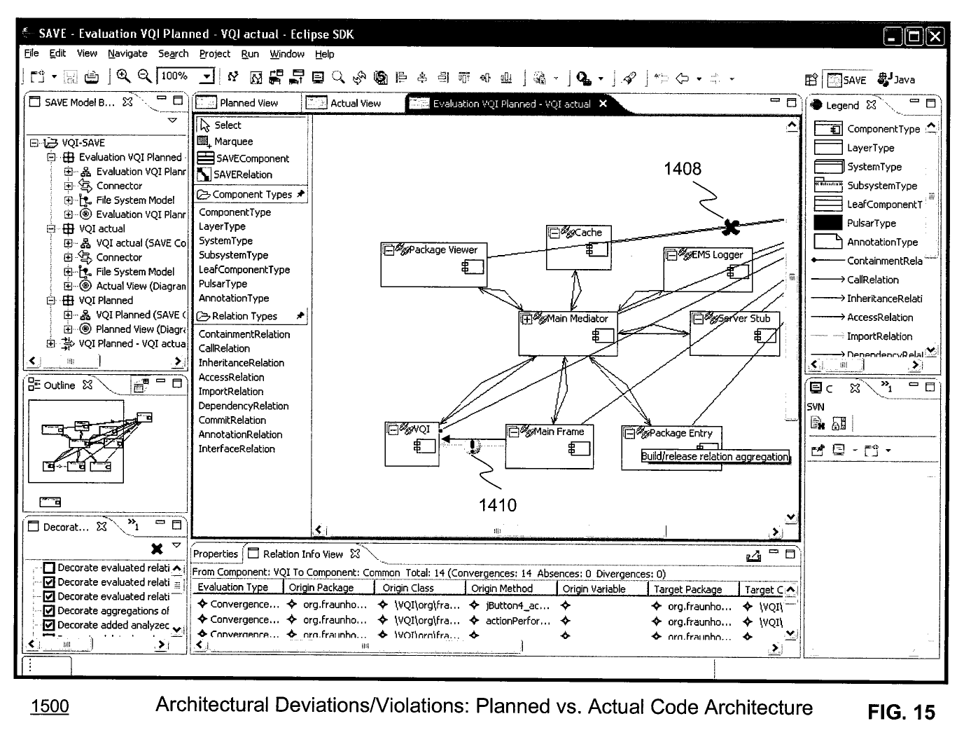

In an embodiment, step 1129 may be aided by use of a graphical display 1200 of the ‘as designed’ or planned architecture and ‘as built’ or code architecture 1300. This step may make use of a provided display depicting portions of the planned and code architectures. The graphical depictions of the planned and code architectures may be displayed in a split window on a screen, or overlaid with deviations denoted or flagged on the display by use of characters, highlighting, emboldening, or color-coding (i.e., deviations in red). For example, FIG. 14 depicts a display 1400 of violations 1191 wherein two categories of violations, 1408 and 1410, between a planned and an actual code architecture are denoted, in accordance with an embodiment of the present invention. As illustrated by FIG. 14, one category of violations, 1408, wherein a dependency is found in the actual code architecture and not found in the planned/designed architecture may be denoted or tagged in display 1400 by exclamation marks. Similarly, another category of violation, 1410, wherein a dependency is found in the planned architecture and not found in the actual code architecture may be denoted with an “x.” FIG. 15 depicts a detailed graphical display 1500 of architectural violations 1408 and 1410 between a planned and an actual code architecture, in accordance with an embodiment of the present invention.

Violations 1191 can be missing or extra components, missing or extra connections between components, deviations from architectural guidelines, or values of metrics that exceed or do not match an expected value (i.e., deviations between the planned versus actual architecture).

The analysis team may compile a list of violations 1191 identified in step 1129. The team may also note the circumstances under which violations 1191 were detected and the reasons the team suspects that any of the deviations are violations. If necessary, the analysis team can conduct a more detailed analysis of deviations 1191 in order to determine their possible cause and degree of severity. According to an embodiment, violations 1191 are categorized and patterns of violations are identified.

In step 1131, violations 1191 are verified to create a list of verified violations 1195. After the analysis team has composed and characterized the list of architectural violations 1191 in step 1129, the list is verified in step 1131. According to an embodiment, the verification may be accomplished by means of collaboration between members of the software development team.

Step 1131 is taken for several reasons. First, it helps ensure that the analysis team has not incorrectly identified any deviations amongst violations 1191 as a result of a misunderstanding of how the software system was implemented. Secondly, step 1131 provides feedback on how closely actual architecture 1127 matches the planned architecture defined in step 1121. Step 1131 also exposes general types of deviations that have occurred between the initial design and the actual software implementation. Additionally, step 1131 enables the analysis team to gather more information on how and why violations 1191 have occurred. The result of step 1131 is to create a list of verified violations 1195.

In step 1133, changes to planned and/or actual architecture 1127 are suggested. According to an embodiment, based on verified violations 1195 identified in step 1131, the analysis team may formulate change recommendations that would remove the deviations from the software system. Verified violations 1195 identified in step 1131 can result in suggestions for source code changes 1135 in step 1133. In accordance with an embodiment of the invention, requests for source code changes 1135 can be related to changes in the planned architecture or guidelines. Step 1133 is a way for the analysis team to improve the software system by providing feedback to the software development team. This feedback is in the form of suggested code changes 1135.

Next suggested code changes 1135 identified in step 1133 are implemented by repeating steps 1121 and 1127. In accordance with an embodiment of the invention, an analysis team may discuss suggested changes 1135 with the software development team that developed the software system. According to an embodiment of the present invention, the development team decides which suggested changes 1135 identified in step 1133 will be implemented and how the changes will be implemented.

If any suggested changes 1135 are implemented, steps 1121 and 1127 are repeated to extract the updated actual architecture. As described above, step 1129 is then repeated to determine if the updated actual architecture 1128 complies with the updated planned software architecture. Before verifying that the planned and actual architectures are aligned, step 1127 is repeated to identify the actual architecture, and any remaining architectural deviations are identified by repeating step 1129. The verification is repeated by executing step 1131 again to ensure that suggested changes 1135 have been implemented correctly and that no new verified violations 1195 have been introduced into the software system.

In step 1139, a decision to repeat steps 1129-1137 is made after changes have been implemented in step 1137. When a decision to perform an additional comparison has been made, step 1129 is repeated to verify that the updated actual architecture complies with the planned code architecture. As discussed above, prior to verifying that the planned and updated actual architectures are aligned in step 1129, steps 1121 and 1127 are repeated to identify the updated planned and actual architectures. A decision to make an additional comparison may be necessary in step 1139 in order to make sure that the changes have been implemented correctly and that no new deviations have been introduced into the software system.

When no additional changes are suggested in step 1133, no changes are to be implemented in step 1137, and no additional comparisons are necessary in step 1139, the method ends in step 1141.

### 5. Client-Server Computer System Implementation

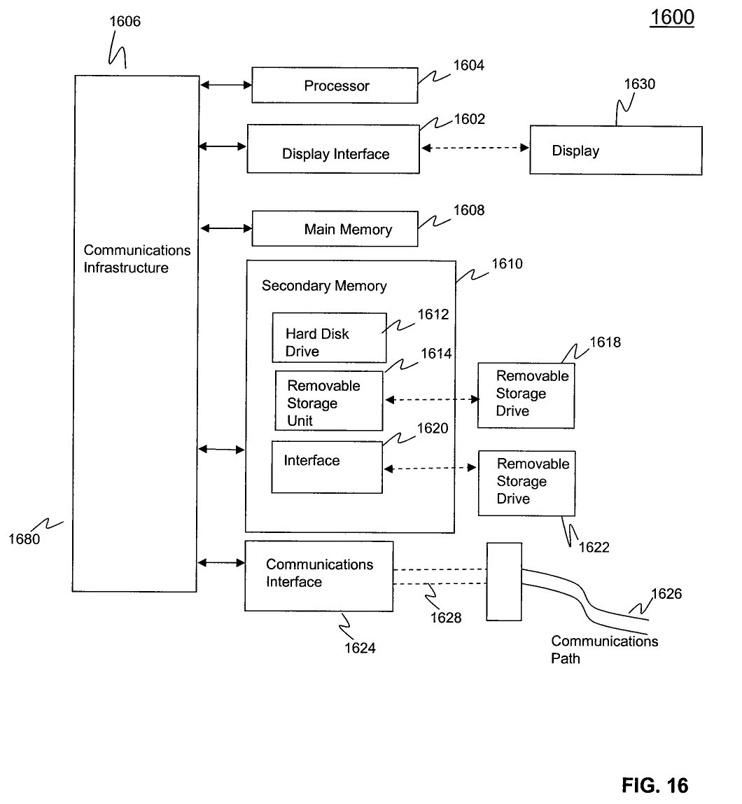

Various aspects of the present invention can be implemented by software, firmware, hardware, or a combination thereof. FIG. 16 illustrates an example computer system 1600 in which the present invention, or portions thereof, can be implemented as computer-readable code. For example, the method illustrated by flowchart 1100 of FIG. 11 can be implemented in system 1600. Various embodiments of the invention are described in terms of this example computer system 1600. After reading this description, it will become apparent to a person skilled in the relevant art how to implement the invention using other computer systems and/or computer architectures.

Computer system 1600 includes one or more processors, such as processor 1604. Processor 1604 can be a special purpose or a general purpose processor. Processor 1604 is connected to a communications infrastructure 1606 (for example, a bus, or network).

In alternative implementations, secondary memory 1610 may include other similar means for allowing computer programs or other instructions to be loaded into computer system 1600. Such means may include, for example, a removable storage drive 1622 and an interface 1620. Examples of such means may include a program cartridge and cartridge interface (such as that found in video game devices), a removable memory chip (such as an EPROM, or PROM) and associated socket, and other removable storage drives 1618 and 1622 and interfaces 1620 which allow software and data to be transferred from the removable storage drive 1622 to computer system 1600.

Computer system 1600 may also include a communications interface 1624. Communications interface 1624 allows software and data to be transferred between computer system 1600 and external devices. Communications interface 1624 may include a modem, a network interface (such as an Ethernet card), a communications port, a PCMCIA slot and card, or the like. Software and data transferred via communications interface 1624 are in the form of signals which may be electronic, electromagnetic, optical, or other signals capable of being received by communications interface 1624. These signals are provided to communications interface 1624 via a communications path 1626. Communications path 1626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1614, removable storage drives 1618 and 1622, and a hard disk installed in hard disk drive 1612. Signals carried over communications path 1626 can also embody the logic described herein. Computer program medium and computer usable medium can also refer to memories, such as main memory 1608 and secondary memory 1610, which can be memory semiconductors (e.g. DRAMs, etc.). These computer program products are means for providing software to computer system 1600.

Computer programs (also called computer control logic) are stored in main memory 1608 and/or secondary memory 1610. Computer programs may also be received via communications interface 1624. Such computer programs, when executed, enable computer system 1600 to implement the present invention as discussed herein. In particular, the computer programs, when executed, enable processor 1604 to implement the processes of the present invention, such as the steps in the process illustrated by FIG. 1 and flowchart 1100 of FIG. 11 discussed above. Accordingly, such computer programs represent controllers of the computer system 1600. Where the invention is implemented using software, the software may be stored in a computer program product and loaded into computer system 1600 using removable storage unit 1614, interface 1620, hard drive 1612, or communications interface 1624.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The invention can work with software, hardware, and/or operating system implementations other than those described herein. Any software, hardware, and operating system implementations suitable for performing the functions described herein can be used.

### 6. CONCLUSION

Embodiments of present invention have been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

What is claimed is:

1. A method for evaluating an implemented software code architecture of a software system, the method comprising:
(a) defining the planned architecture for the system;
(b) extracting the implemented software code architecture from the source code of the system;
(c) comparing the actual architecture extracted in step (b) to the planned architecture defined in step (a) to identify architectural deviations; and
(d) suggesting changes to the architecture based upon the architectural deviations.

2. The method of claim 1, further comprising:
(e) implementing changes suggested in step (d).

3. The method of claim 2, further comprising:
repeating steps (b)-(d) to determine if any new deviations have been introduced into the system as a result of changes implemented in step (e).

4. The method of claim 1, wherein step (a) further comprises using system design information to define the planned architecture for the system.

5. The method of claim 1, wherein step (a) further comprises using system specifications to define the planned architecture for the system.

6. The method of claim 1, wherein step (a) further comprises using system design information to define the planned architecture for the system.

7. The method of claim 1, wherein step (a) further comprises selecting a perspective to determine if the system implements specific functional requirements.

8. The method of claim 1, wherein step (a) further comprises selecting a perspective to determine if the system fulfills non-functional requirements.

9. The method of claim 8, wherein the non-functional requirements include one or more of software system quality attributes, security attributes, reliability attributes, flexibility attributes, extensibility attributes, modifiability attributes, performance attributes, and maintainability attributes.

10. The method of claim 1, wherein step (a) further comprises identifying goals and measurement metrics for the architectural evaluation.

11. The method of claim 10, wherein the Goal, Question, Metric (GQM) technique is used to define goal-oriented measurement metrics based on questions that need to be answered to determine if the identified goals have been achieved.

12. The method of claim 10, wherein the measurement metrics include the extent of the coupling between components of the system.

13. The method of claim 1, wherein step (d) further comprises suggesting changes to the planned architecture based upon the architectural deviations.

14. The method of claim 1, wherein step (c) comprises comparing an abstraction of the planned architecture defined in step (a) to an abstraction of the code architecture extracted in step (b), wherein the respective levels of the abstractions match.

15. The method of claim 1, wherein the deviations include one or more of missing components, extra components, missing connections, extra connections between components, violations of architectural guidelines, values of metrics that exceed an expected threshold value, and values of metrics that do not match an expected value.

16. The method of claim 1, wherein step (c) further comprises determining the possible cause and severity of each violation.

17. The method of claim 1, wherein step (c) further comprises categorizing deviations.

18. The method of claim 1, wherein step (c) further comprises identifying patterns of deviations.

19. A system for evaluating the code architecture of a software system, the evaluation system comprising:
an architecture definition module configured to define the planned architecture of the system, wherein the defined architecture includes at least design metrics and architecture evaluation guidelines;
a fact extraction module configured to extract the code architecture from the source code of the system;
a mapping module configured to create a mapping of items in the code architecture to items in the planned architecture;
a comparison module configured to compare the code architecture extracted by the fact extraction module to the planned architecture defined by the architecture definition module to identify architectural deviations, wherein the comparison is guided by the mapping; and
a display module configured to graphically display the architectural deviations identified by the comparison module.

20. The system of claim 19, wherein the comparison module is configured to compare an abstraction of the planned architecture to an abstraction of the actual architecture extracted by the fact extraction module, wherein level of the abstractions match.

21. The system of claim 19, wherein the deviations identified by the comparison module include one or more of missing software system components, extra software system components, missing connections between software system components, extra connections between software system components, violations of architectural guidelines, values of metrics that exceed an expected threshold value, and values of metrics that do not match an expected value.

22. The system of claim 19, wherein the comparison module is configured to determine the possible cause and severity of each violation.

23. A computer program product comprising a computer usable medium having computer program logic recorded thereon for enabling a processor to evaluate the code architecture of a software system, the computer program logic comprising:
defining means for enabling a processor to define the planned architecture and evaluation guidelines for the system;
extracting means for enabling a processor to extract the code architecture from the source code of the system;
comparing means for enabling a processor to compare the code architecture extracted by the extracting means to the planned architecture defined by the defining means in order to identify and display architectural deviations; and
requesting means for enabling a processor to a request changes to the code architecture based upon architectural deviations identified by the comparing means.

24. The computer program product of claim 23, wherein the extracting means is further configured to parse the software system's source code to extract facts needed to display, evaluate, and update the code architecture of the software system from the source code.

25. The computer program product of claim 23, wherein the extracting means is further configured to identify entities containing programming language constructs corresponding to components of the software system, wherein entities include one or more of functions, variables, parameters, procedures, data types, data structures, applets, and methods.

26. The computer program product of claim 23, wherein the extracting means is further configured to construct a parse tree for each software source code file, wherein the parse tree includes at least nodes corresponding to the source code files of the software system.

27. The computer program product of claim 26, wherein the extracting means is further configured to traverse and analyze each node of the parse tree in order to identify entities accessed by each node.

28. The computer program product of claim 27, wherein the extracting means is further configured to identify compilation units in which the entities are declared.

29. The computer program product of claim 28, wherein the extracting means is further configured to construct a file system aspect of the software system, wherein the file system aspect includes at least relationships between files of the software system, and wherein relationships are based upon one or more of entities accessed by each node, compilation units in which the entities are declared, and declarations in which the nodes reside.
